(19) United States
(12) Patent Application Publication
(10) Pub. No.: US 2016/0104198 A1
(43) Pub. Date: Apr. 14, 2016

(54) AUTOMOBILE INCIDENT DATA NETWORKING PLATFORM

(71) Applicant: Smith Luby Holdings, LLC, Norcross, GA (US)

(72) Inventors: William Michael Smith, Norcross, GA (US); Zeus Cory Luby, Snellville, GA (US)

(21) Appl. No.: 14/514,012

(22) Filed: Oct. 14, 2014

(51) Int. Cl. G06Q 30/02

(52) U.S. Cl. CPC G06Q 30/0257; G06Q 30/0267; G06Q 30/0261

(57) ABSTRACT

An automobile incident data networking platform may be provided to help consumers navigate the intersection between everyday driving and the laws of the road. The platform may capture data and information related to traffic incidents. Whether it's a severe auto accident, fender bender, speeding ticket, routine traffic ticket, or a DUI, the platform may help consumers preserve data/evidence and instructs them how to utilize that data to protect themselves and preserve their rights. Still consistent with embodiments of the present disclosure, the platform may comprise a network for consumers to find service providers connected to issues involving traffic incidents. This includes, but is not limited to, for example, personal injury attorneys, DUI attorneys, car repair shops, auto glass repair shops, car dealerships, insurance agencies, and so forth. These service providers may be enabled to interface with the consumer through the platform, viewing incident data and providing quotes in response thereto.

### FIELD OF DISCLOSURE

The present disclosure generally relates to automobile incidents and networking individuals with service providers.

### BACKGROUND

In some situations, an individual may have an automobile incident such as an accident, a citation for a traffic violation, or arrest for driving under the influence. As a result, the individual may need the assistance of a service provider, such as an attorney or insurance company. The conventional method would require the individual to manually gather all necessary information such as, but not limited to, pictures and video of the incident aftermath, witness testimony and police officer information. This often causes problems, as the individual may not know what information to gather and have difficulty consolidating the information without losing any essential elements therein. Then, under the conventional method, the individual would need to find a service provider to assist the individual in taking the proper course of action to resolve the automobile incident. Finding a well-qualified and reasonably priced service provider presents yet another hurdle that the individual must overcome in resolving the automobile incident.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

An automobile incident data networking platform may be provided to help consumers navigate the intersection between everyday driving and the laws of the road. The platform may capture data and information related to traffic incidents. Whether it's a severe auto accident, fender bender, speeding ticket, routine traffic ticket, or a DUI, the platform may help consumers preserve data/evidence and instructs them how to utilize that data to protect themselves and preserve their rights. Additionally, the platform may help individuals contact emergency services, as well as friends and loved ones in emergencies on the road. Furthermore, the platform may allow drivers to immediately call an emergency provider as well as send texts and emails to friends and family that alerts them that they are in an emergency situation and it gives them the GPS generated location of the emergency.

Still consistent with embodiments of the present disclosure, the platform may comprise a network for consumers to find service providers connected to issues involving traffic incidents. This includes, but is not limited to, for example, personal injury attorneys, DUI attorneys, car repair shops, auto glass repair shops, car dealerships, insurance agencies, and so forth. These service providers may be enabled to interface with the consumer through the platform, viewing the incident data and providing quotes in response thereto. The consumer may then select, through the platform, at least one desired service provider to handle the incident or portions thereof.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a platform consistent with embodiments of the present disclosure;

FIG. 2A is a flow chart of a method for providing an automobile incident data networking platform;

FIG. 2B is a flow chart of a method for providing platform for directing interaction between a user and service provider;

FIG. 3 is an illustration of an embodiment for selecting the submission type consistent with the present disclosure;

FIG. 4 illustrates an emergency menu consistent with embodiments of the present disclosure;

FIG. 5 illustrates an embodiment of a prompt for enabling the user to add or edit more contact information;

FIG. 6 illustrates a menu for the user to add data pertaining to an accident consistent with embodiments of the present disclosure;

FIG. 7 illustrates an embodiment for the location display consistent with the present disclosure;

FIG. 8 illustrates a menu for adding photos consistent with embodiments of the disclosure;

FIG. 9 illustrates a menu for inputting information for another party involved in the incident consistent with embodiments of the disclosure;

FIG. 10 illustrates a menu for inputting information for another vehicle involved in the incident consistent with embodiments of the disclosure;

FIG. 11 illustrates a menu for inputting information for one or more responders involved in the incident consistent with embodiments of the disclosure;

FIG. 12 illustrates a menu for adding photos consistent with embodiments of the disclosure;

FIG. 13 illustrates a menu for witness data collection consistent with embodiments of the disclosure;

FIG. 14 illustrates an example of a ticket menu consistent with embodiments of the present disclosure; and

FIG. 15 is a block diagram of a system including a computing device for performing the method of FIG. 2.

### DETAILED DESCRIPTION

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

### I. Platform Overview

An automobile incident data networking platform may be provided. This platform may facilitate a network of service providers and provide consumers access to that network of service providers. Service providers may include, for example, but not be limited to, attorneys, insurance companies and body shops. The platform may enable consumers to communicate with those service providers with case specific information. This may be accomplished by, for example, enabling the consumers to provide case specific information to the service providers through the platform of the present disclosure. In turn, the platform may enable the service providers to informatively bid on the consumer's matter. Further, the platform may empower the consumer to select the service provider he or she wishes to work with.

### II. Platform Configuration

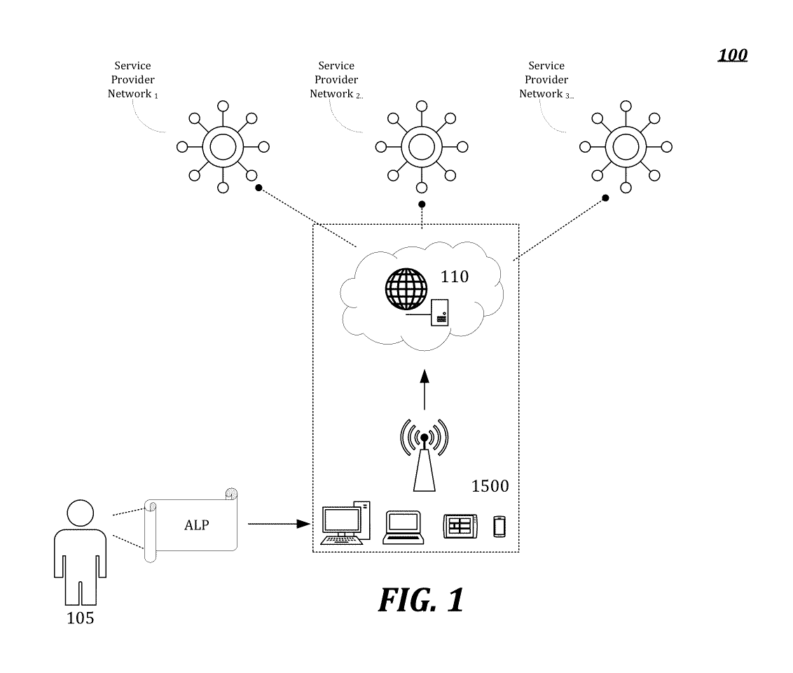

FIG. 1 illustrates one possible operating environment through which a platform consistent with embodiments of the present disclosure may be provided. By way of non-limiting example, an automobile incident data networking platform 100 may be hosted on a centralized server 110, such as, for example, a cloud computing service. A user 105 may access platform 100 through a software application. The software application may be embodied as, for example, but not be limited to, a website, a web application, a desktop application, and a mobile application compatible with a computing device 1500. One possible embodiment of the software application may be provided by the Auto Law Pro™ suite of products and services.

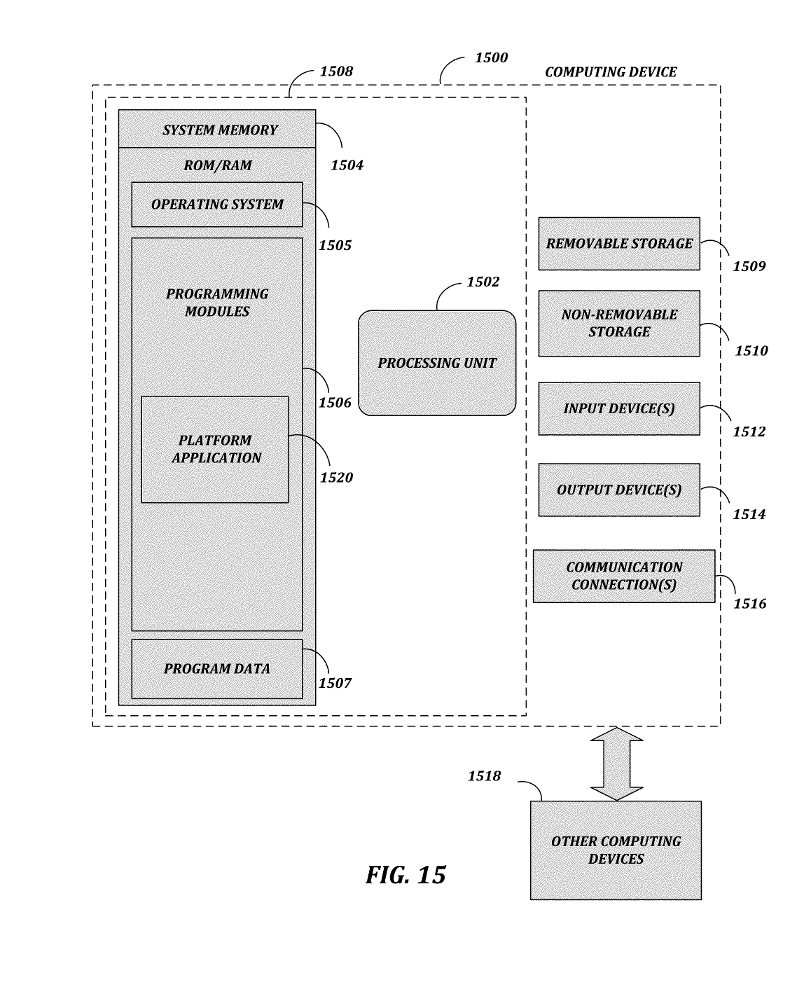

As will be detailed with reference to FIG. 15 below, the computing device through which the platform may be accessed may comprise, but not be limited to, for example, a desktop computer, laptop, a tablet, or mobile telecommunications device. As will be detailed with reference to FIG. 15 below, the computing device through which the platform may be accessed may comprise, but not be limited to, for example, a desktop computer, laptop, a tablet, or mobile telecommunications device. Though the present disclosure is written with reference to a mobile telecommunications device, it should be understood that any computing device may be employed to provide the various embodiments disclosed herein.

The platform may further be comprised of a plurality of registered service providers related to issues involving traffic incidents, such as, for example, personal injury attorneys, DUI attorneys, car repair shops, auto glass repair shops, car dealerships, insurance agencies.

The platform components may be accessed and/or configured by a user via an admin portal provided by, for example, the software application. The admin portal may provide a dashboard including search capability and diagnostics. Furthermore, the admin portal may enable the user to set various configuration, security, and operational parameters.

The platform may capture data and evidence related to traffic incidents such as, for example, a severe auto accident, fender bender, speeding ticket, routine traffic ticket, or a DUI. Further, the platform may enable users store data and evidence. The platform may determine the location of the user by utilizing methods, such as, for example, GPS, Wi-Fi, or triangulation of cell phone service towers. Moreover, the platform may enable users to utilize that data in communication with service providers. Additionally, the platform may also enable users to contact emergency services, as well as friends and family in emergencies on the road. The platform may enable users to send texts and emails to friends and family that alerts them that they are in an emergency situation.

### III. Platform Operation

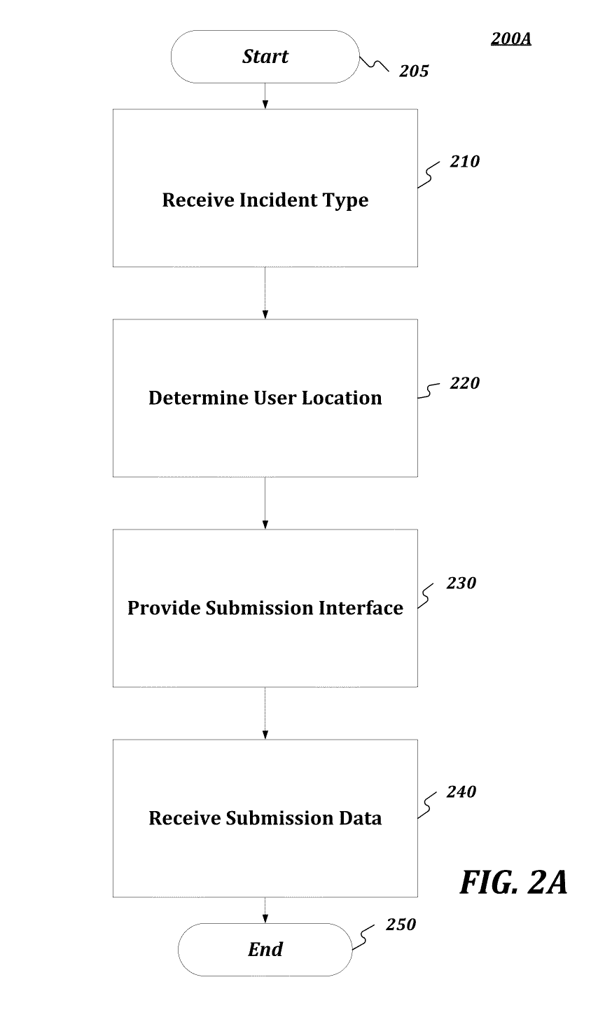

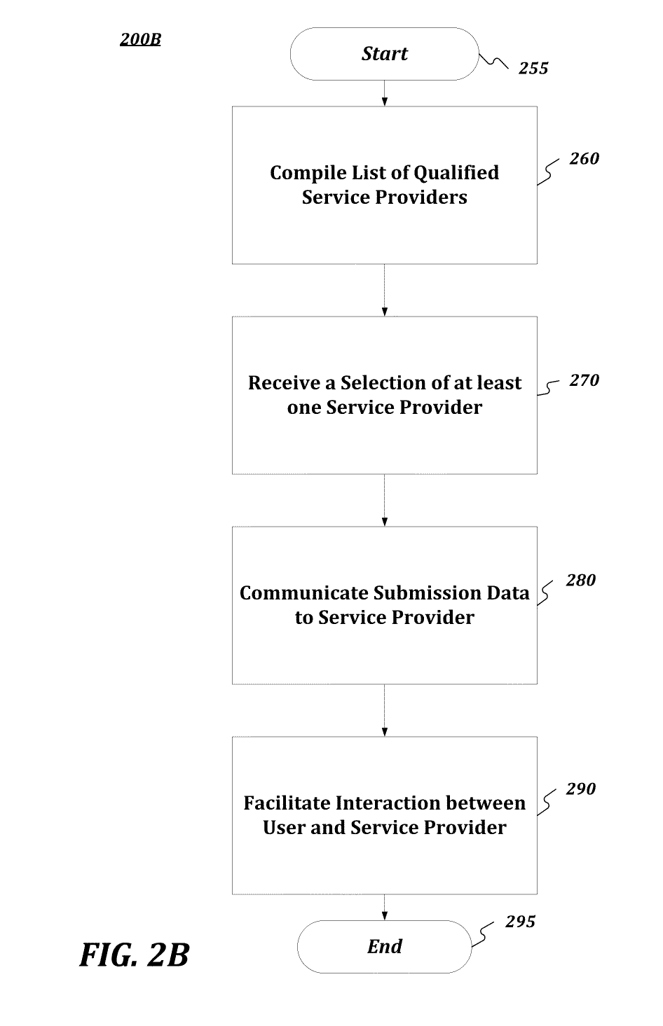

FIG. 2A is a flow chart setting forth the general stages involved in a method 200A consistent with an embodiment of the disclosure for providing an automobile incident networking platform 100. Method 200A may be implemented using a computing device 1500 as described in more detail below with respect to FIG. 15.

Although method 200A has been described to be performed by platform 100, it should be understood that computing device 1500 may be used to perform the various stages of method 200A. Furthermore, in some embodiments, different operations may be performed by different networked elements in operative communication with computing device 1500. For example, server 110 may be employed in the performance of some or all of the stages in method 200A. Moreover, server 110 may be configured much like computing device 1500.

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of method 200 will be described in greater detail below.

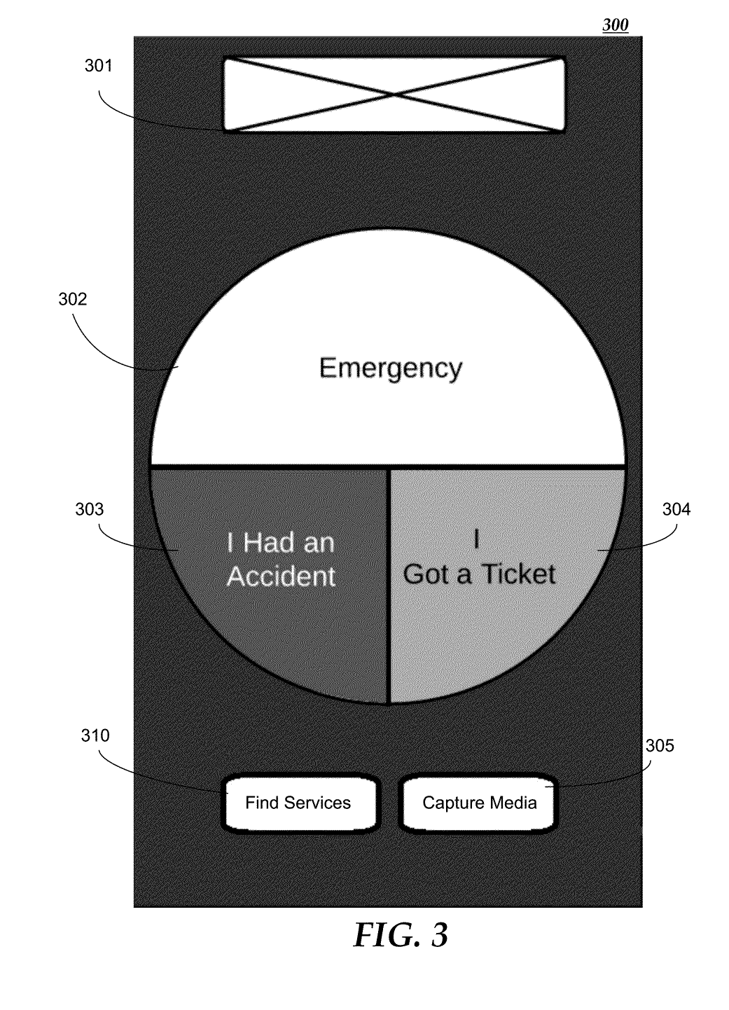

Method 200A may begin at starting block 205 and proceed to stage 210 where computing device 1500 may receive a submission type. For example, submission types may include an emergency, an accident or a ticket. FIG. 3 shows an illustration of an embodiment of a home interface 300 for selecting the submission type consistent with the present disclosure. A placeholder image or text 301 may be provided. Emergency button 302 may be a user selectable button corresponding to an emergency submission type; accident button 303 may be a user selectable button corresponding to an accident submission type; and ticket button 304 may be a button corresponding to a traffic ticket type.

In addition, a capture media button 305 may enable the user to capture multimedia content for storage and/or communication. A user may select button 305 and, in response thereto, platform 100 may enable a recording interface to be provided. The recording interface may enable the user to capture images, videos, and/or audio files. Upon capture, platform 100 may communicate the captured media to a plurality of specified contacts (as will be better understood below) and return to home interface 300.

Furthermore, a find services button 310 may be provided. Upon selection of find services button 310, platform 100 may provide, to the user, a listing of service providers registered with platform 100. As will be detailed below, service providers may be registered and vetted through platform 100. In this way, the user may quickly access, for example, a sortable and searchable service provider list, thereby enabling the user to select a fitting service provider for an incident.

From stage 210A, where computing device 1500 may receive a submission type, method 200A may advance to stage 220 where computing device 1500 may optionally determine the user location. The user location may be determined, for example, by GPS, Wi-Fi, or triangulation of cell phone service towers. Alternatively, the user may be able to select the location of the incident. This may be accomplished, for example, by entering an address in text or by selecting a location on a map.

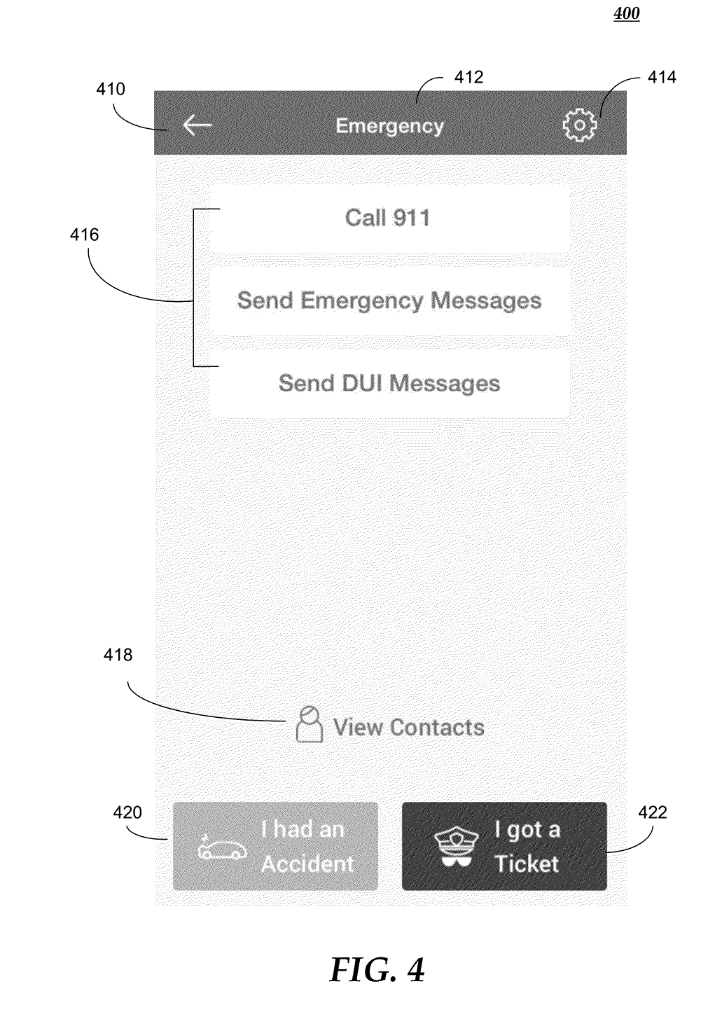

Once computing device 1500 determines the user location in stage 220, method 200A may continue to stage 230 where computing device 1500 may provide a submission interface. For example, upon a selection of emergency button 302, an emergency interface may be provided. FIG. 4 illustrates an emergency interface 400 consistent with embodiments of the present disclosure. Emergency interface 400 may be comprised of, for example, a navigation button 410; a title menu 412; a settings button 414; a series of buttons for contacting specific groups 416, such as, for example, 911, emergency contacts and DUI contacts; a button 418 for viewing contacts; a button 420 for reporting accident information; and a button for reporting information for a ticket 422.

Selecting “CALL 911” may take the user to the communication module (i.e., phone section) of their device with the number 911 pre-dialed. Once the call is complete, the device may return to emergency interface 400. Selecting “SEND EMERGENCY MESSAGES” may automatically notify any pre-selected contacts via SMS or MMS messages. The messages may include the location information detected for the user and a pre-determined message provided by the user or an administrator of the platform. Selecting the “SEND DUI Messages” may automatically notify any people via text that have been marked as DUI contacts in the contacts interface described below. Messages may be sent at regular intervals until recipient acknowledges receipt of the message.

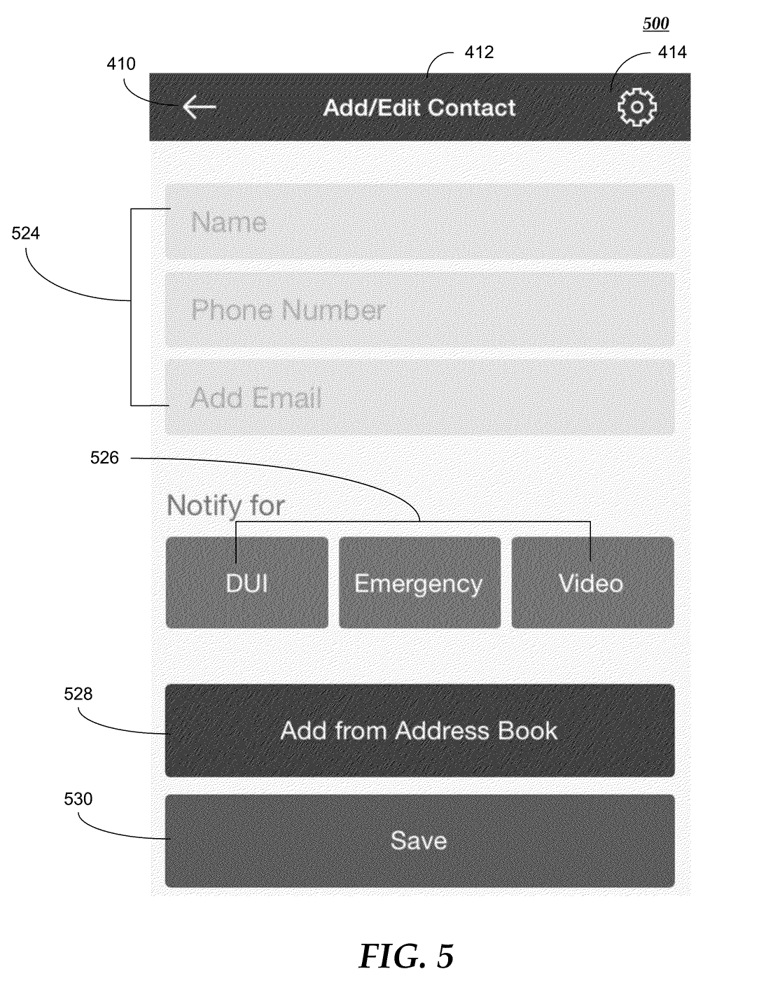

Upon selection of button 418, computing device 1500 may prompt the user adding or editing contact information. FIG. 5 illustrates an embodiment of a prompt 500 for enabling the user to add or edit more contact information. The add and edit contact menu may be comprised of, for example, a series of prompts 524 for adding contact information; a series of buttons for determining when the described contact should be contacted (e.g., during a DUI, Emergency, and/or Video capture), 526; a save button 530 enabling the user to add contacts from the address book, 528; and a button for saving information.

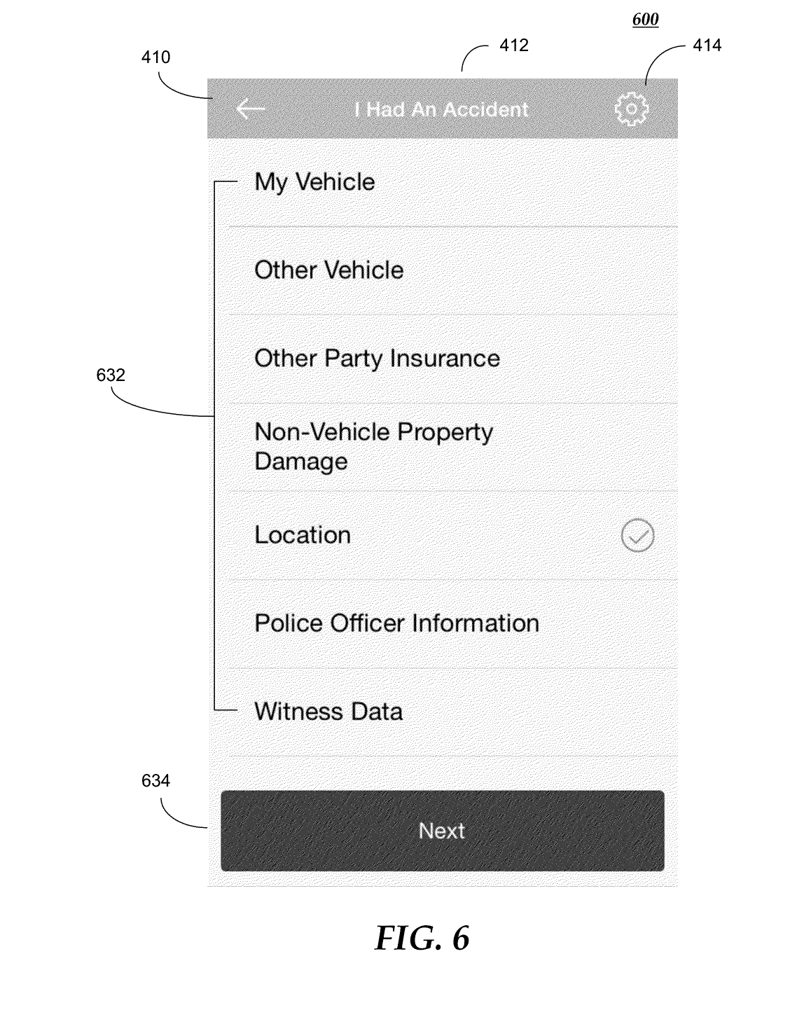

Upon selection of accident button 303, computing device 1500 may show a menu for the user to add data pertaining to an accident. FIG. 6 illustrates a menu 600 for the user to add data pertaining to an accident consistent with embodiments of the present disclosure. This menu may be comprised of a series of prompts 632 for adding information and a next button 634. Upon selection of the next button 634, computing device 1500 may enable the user to navigate a series of interfaces for inputting the accident data. Upon completion of data input, a check may appear next to the corresponding prompt in menu 600.

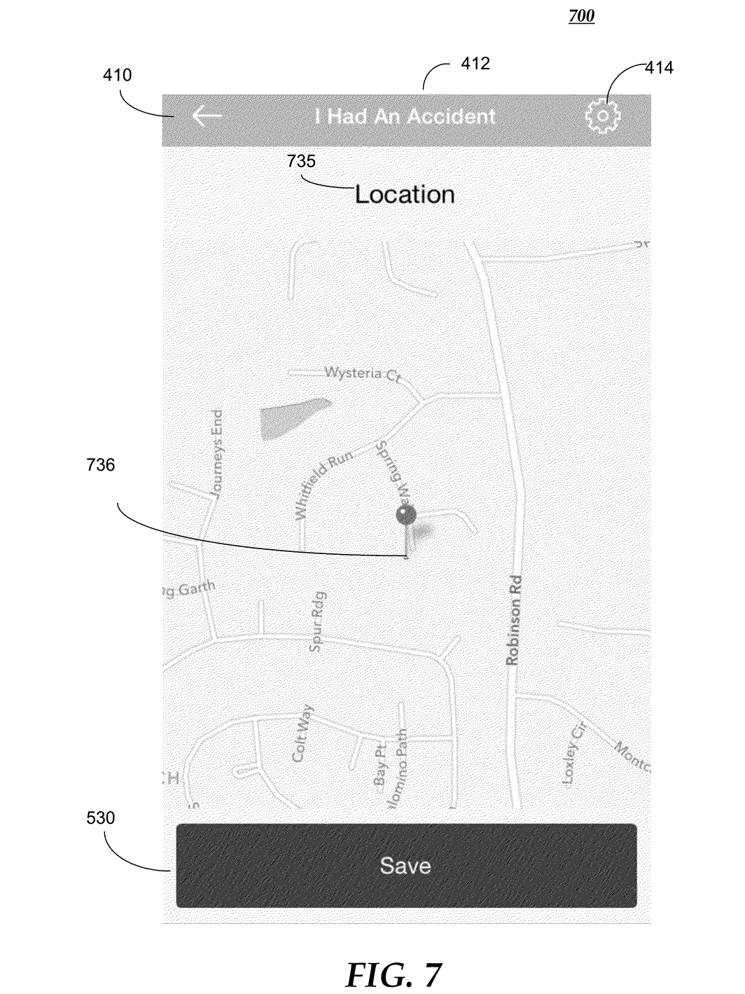

For example, a user may input a location of the accident. FIG. 7 illustrates an embodiment for the location display 700 consistent with the present disclosure. Subtitle 735 may also be shown. A user may drop a pin 736 within a map associated with their location. In some embodiments, the location may be automatically detected using the location detection components described above. The user may confirm the location information by selecting save button 530.

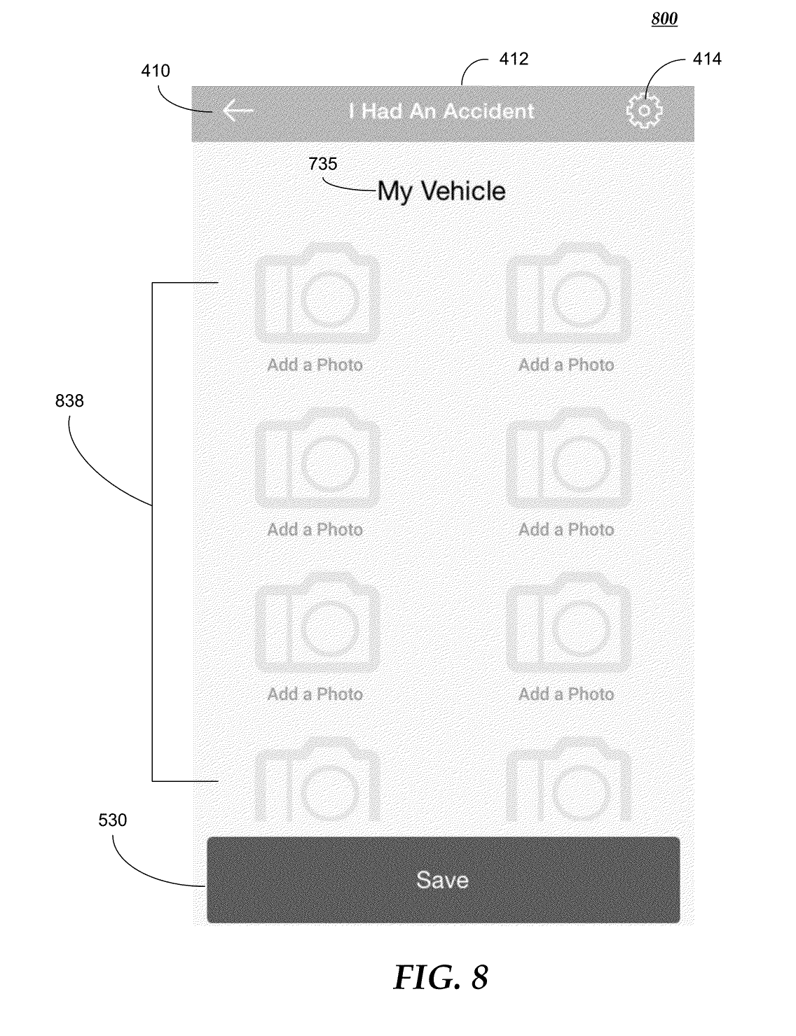

Furthermore, a user may be enabled to take pictures of their vehicle after the accident. FIG. 8 illustrates a My Vehicle interface 800 for adding photos consistent with embodiments of the disclosure. For example, by selecting photo buttons 838, computing device 1500 may enable a camera on a smartphone for taking and saving photos. Further, computing device 1500 may display photos in thumbnail form. Subtitle 735 may also be shown. The user may confirm the photo data by selecting save button 530.

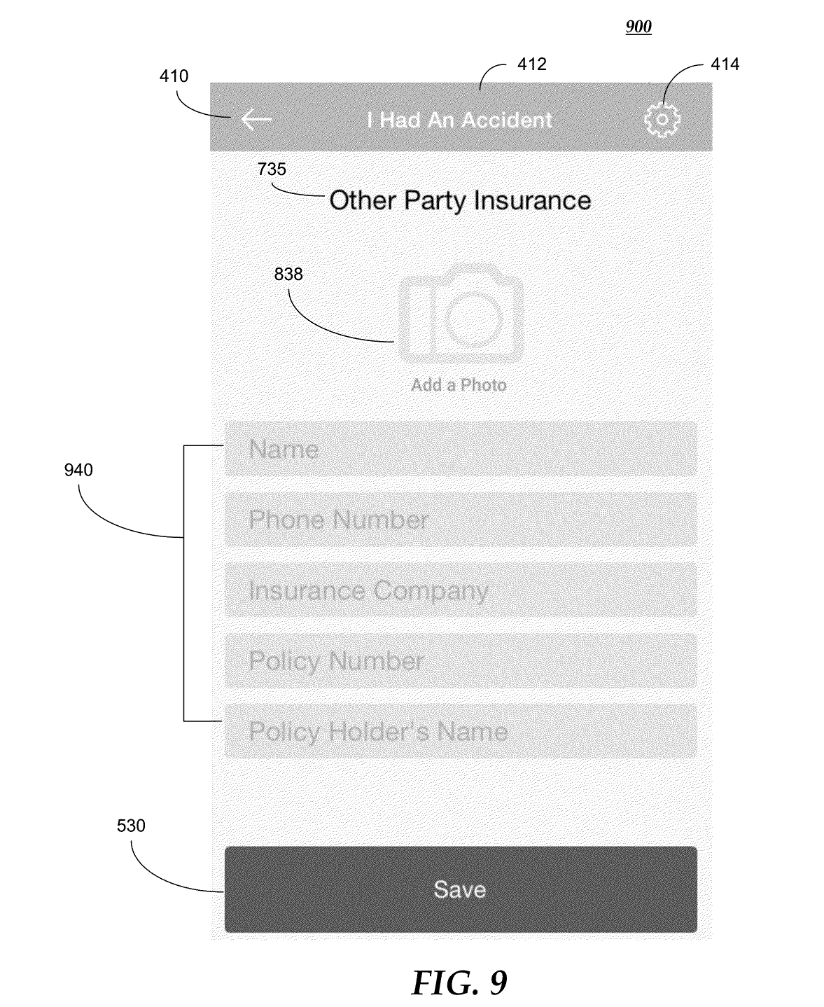

Once computing device 1500 enables the user to take further photos, computing device 1500 may enable the user to add information for one or more parties involved in the incident. FIG. 9 illustrates an other party input interface 900 for inputting information for another party involved in the incident consistent with embodiments of the disclosure. For example, the menu for adding information for one or more parties in the incident may be comprised of photo button 838 and prompts 940. The user may confirm the other party data by selecting save button 530.

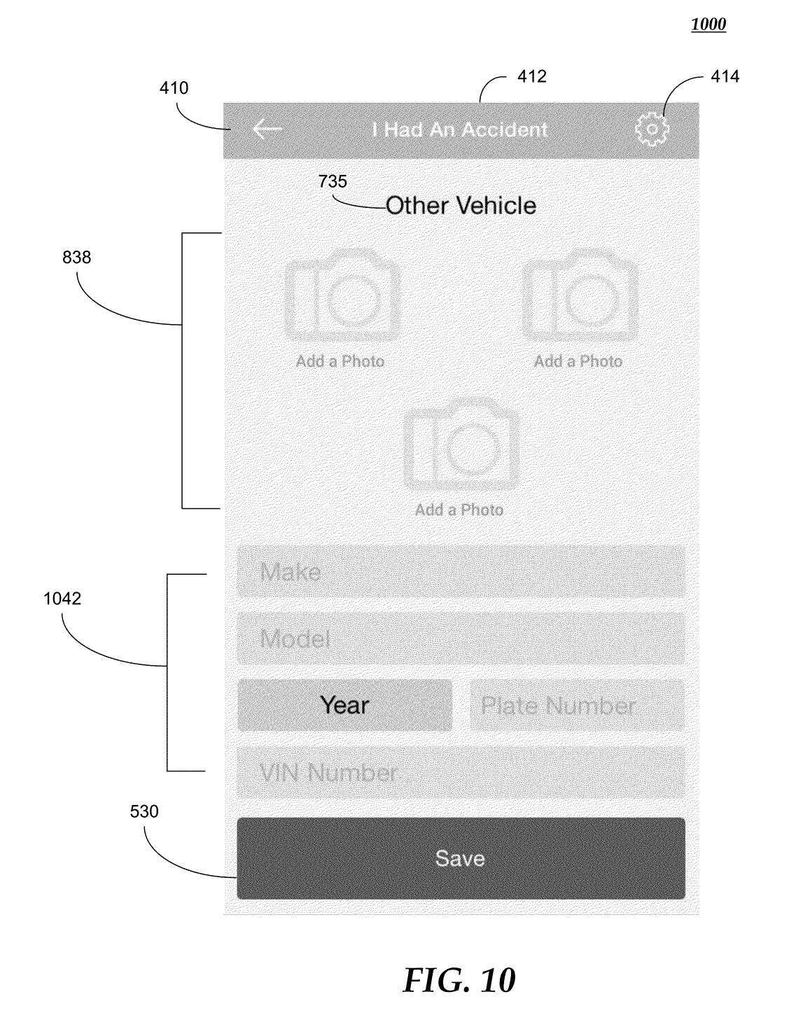

Once computing device 1500 enables the user to add information for one or more parties involved in the incident, computing device 1500 may enable the user to add information for one or more vehicles involved in the incident. FIG. 10 illustrates an other vehicle interface 1000 for inputting information for another vehicle involved in the incident consistent with embodiments of the disclosure. For example, the menu for adding information for one or more parties in the incident may be comprised of prompts 1042 (e.g., make, model, year, license plate number and VIN number) and photo buttons 838. The user may confirm the other vehicle data by selecting save button 530.

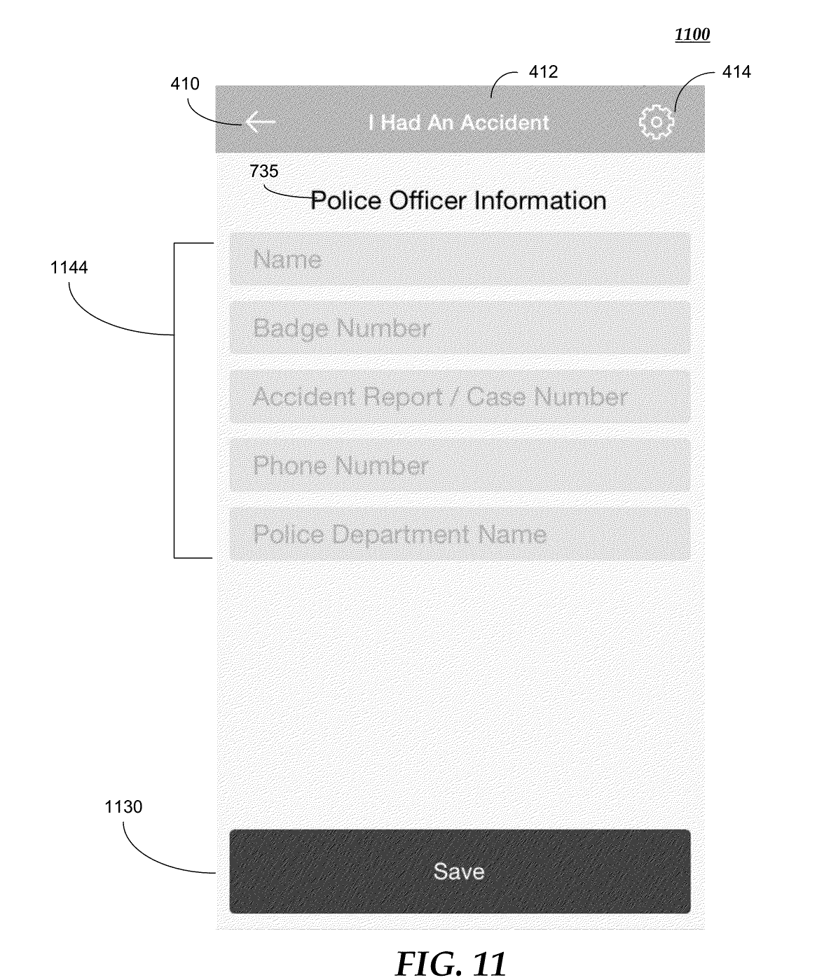

Once computing device 1500 enables the user to add information for one or more vehicles involved in the incident, computing device 1500 may enable the user to add information for one or more responders involved in the incident, such as, for example, a police officer or firefighter. FIG. 11 illustrates a first responder interface 1100 for inputting information for one or more responders involved in the incident consistent with embodiments of the disclosure. For example, the menu for adding information for one or more responders in the incident may be comprised of prompts 1144 (e.g., name, badge number, accident report/case number, phone number and police department name). The user may confirm the other vehicle data by selecting save button 530.

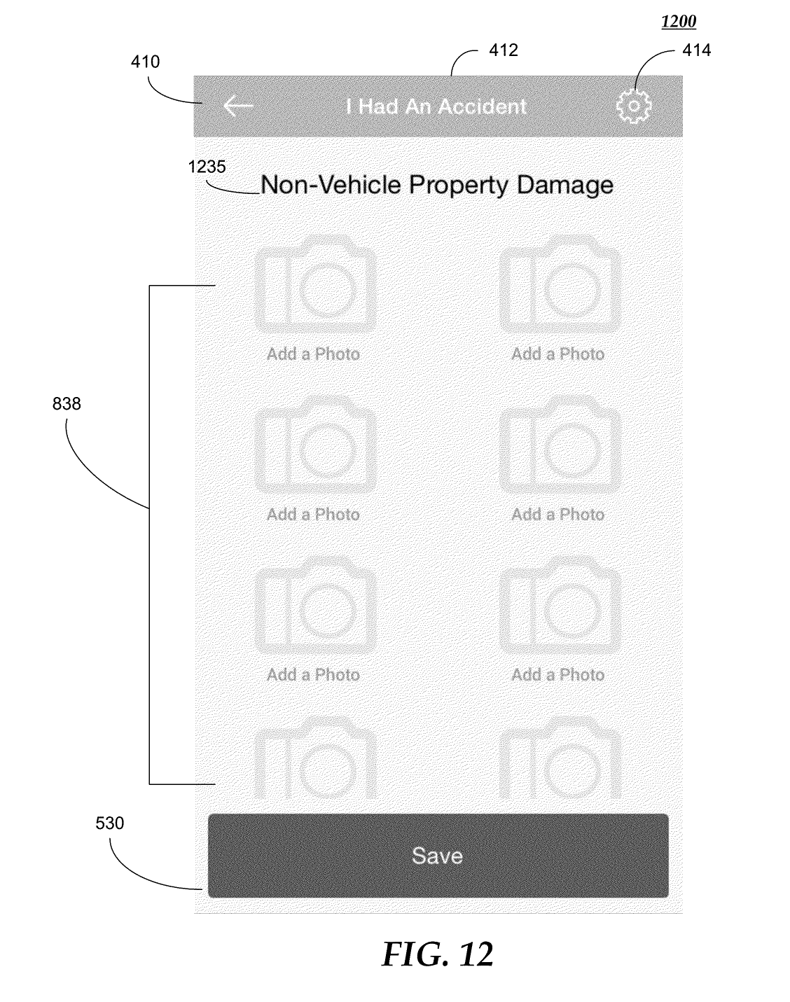

Once computing device 1500 enables the user to add information for one or more responders involved in the incident, computing device 1500 may enable the user to add one or more photos pertaining to non-vehicle property damage. FIG. 12 illustrates a non-vehicle property damage interface 1200 for adding photos, via photo buttons 838, consistent with embodiments of the disclosure. The user may confirm the non-vehicle damage data by selecting save button 530.

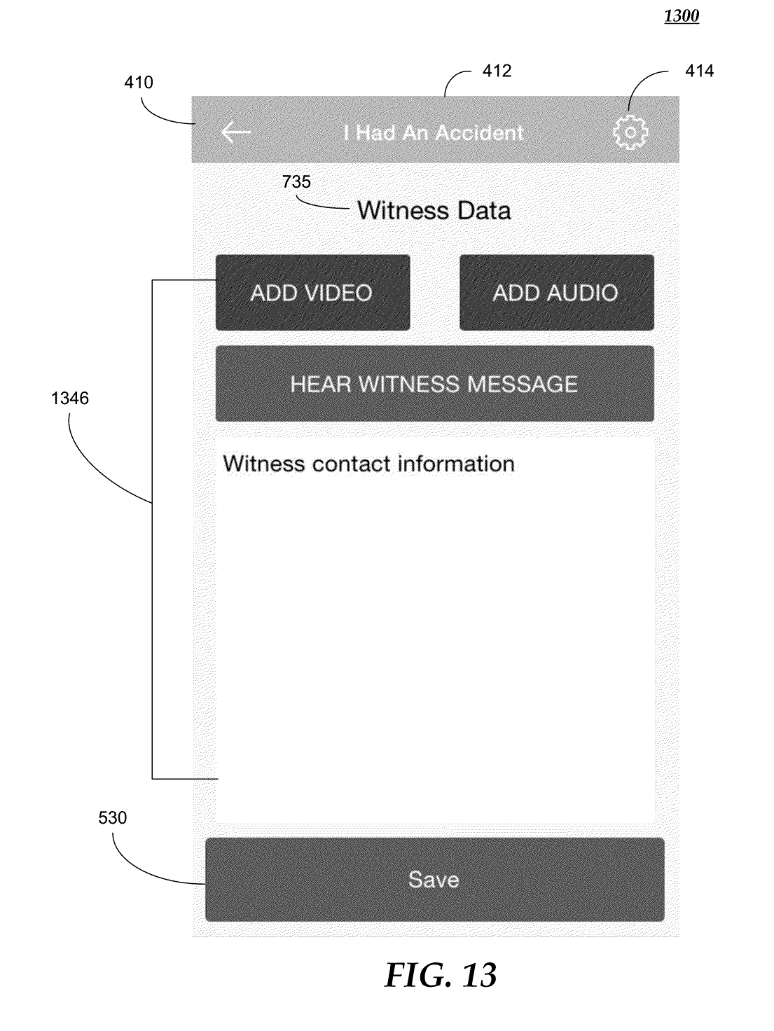

Once computing device 1500 enables the user to add information for one or more photos pertaining to non-vehicle property damage, computing device 1500 may enable the user to add witness data. FIG. 13 illustrates a menu for witness data collection consistent with embodiments of the disclosure. For example, the menu for witness data may be comprised of prompts 1346. Prompts 1346 may, for example, enable the user to add a video, add audio, playback audio, and add textual information received from the witness. The user may confirm the witness data by selecting save button 530.

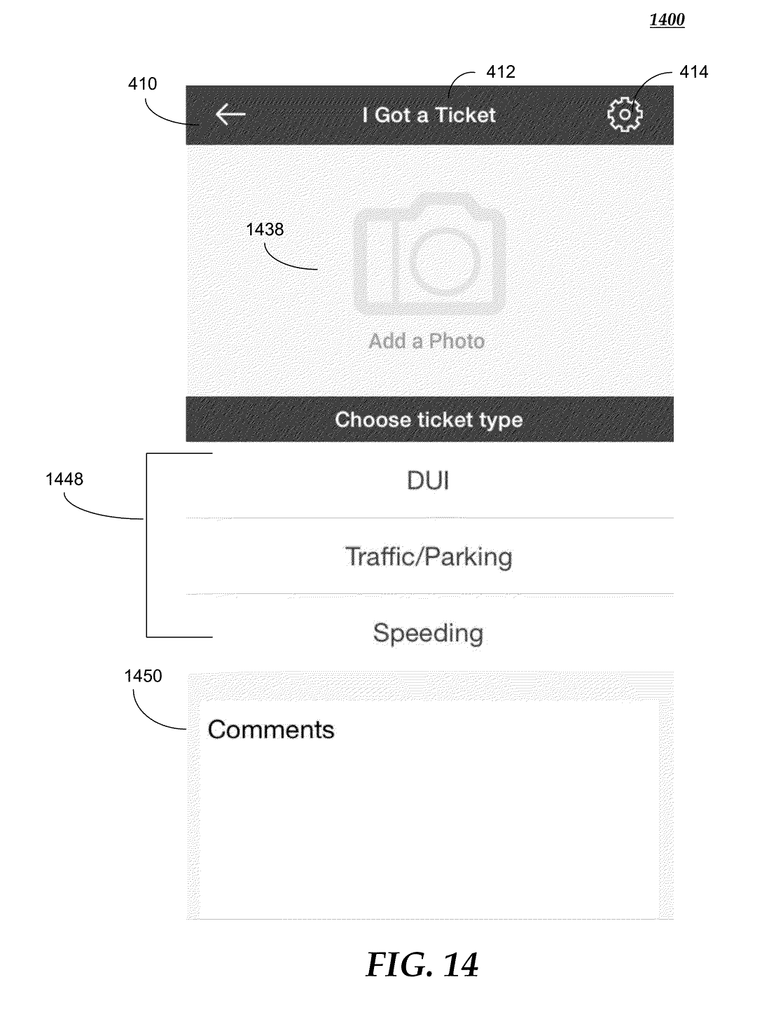

Upon selection of ticket button 304, a ticket menu may be provided. FIG. 14 illustrates an example of a ticket menu consistent with embodiments of the present disclosure. The menu may be comprised of one or more photo buttons 838, prompts for selecting the ticket type (e.g., DUI, traffic/parking, speeding), and a prompt for comments. A next button may not be activated until at least a photo of the ticket has been received.

After computing device 1500 provides a submission interface in stage 230, method 200A may proceed to stage 240 where computing device 1500 may receive submission data. For example, the data may be sent to server 110 which may comprise a database for storage. Once computing device 1500 receives submission data in stage 240, method 200A may then end at stage 250.

FIG. 2B is a flow chart setting forth the general stages involved in a method 200B consistent with an embodiment of the disclosure for providing an automobile incident networking platform 100. Method 200B may be implemented using a computing device 1500 as described in more detail below with respect to FIG. 15.

Although method 200B has been described to be performed by platform 100, it should be understood that computing device 1500 may be used to perform the various stages of method 200B. Furthermore, in some embodiments, different operations may be performed by different networked elements in operative communication with computing device 1500. For example, server 110 may be employed in the performance of some or all of the stages in method 200B. Moreover, server 110 may be configured much like computing device 1500.

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of method 200 will be described in greater detail below.

Method 200B may begin at starting block 255 and proceed to stage 260 where computing device 1500 may compile a list of qualified service providers. For example, in the case of an automobile accident, relevant service providers may be determined, such as, for example, body shops, insurance companies and personal injury lawyers. These entities may be pre-registered as service providers associated with the platform. The pre-registration may include a vetting process to ensure quality control. These service providers may then be provided to the user, via platform 100. The service providers may include their information, any recommendations associated with the incident, and a quote for which the service provider is willing to resolve the incident or a portion thereof.

From stage 260 where computing device 1500 determines a list of qualified service providers, method 200B may proceed to stage 270, where computing device 1500 may receive a selection of at least one service provider. For example, if the user has indicated, through the platform, that he or she received a ticket for a DUI, computing device 200 may display available DUI attorneys. In addition, and as mentioned above, the user may receive further information pertaining to the relevant service providers, including description, ratings, potential fees, etc. Similarly, other service providers associated with the incident type may be listed to the user. The user may then select one or more of the listed service providers to engage in dialog with the service provider regarding the matter.

From stage 270 where computing device 1500 receives a selection of at least one service provider, method 200B may proceed to stage 280, where computing device 1500 may communicate submission data to one or more service providers. For example, the user who received a ticket for a DUI may select from a list one or more DUI lawyers to whom the user would like to send the collected information. In some embodiments, the platform may choose to redact certain data that may not be relevant to the service provider. For instance, in the event of an auto-accident, a body shop may not need to receive witness data or first responder data. Accordingly, platform 100 may be configured to send the data that is pertinent to the particular service provider, while redacting other unrelated data. In this way, a degree of user privacy may be provided.

From stage 280 where computing device 1500 communicates submission data to one or more service providers, method 200B may proceed to stage 290, where computing device 1500 may facilitate interaction between the user and one or more service providers. For example, the selected service providers may receive all of the relevant data captured by the user, such as, for example, the location, time and date, pictures, audio, video, witness information and the information of the police officer who was on the scene. The service providers may then follow up with the user, by, for example, sending price quotes or other relevant information. Once computing device 1500 facilitates interaction between the user and one or more service providers in stage 290, method 200B may end at 295.

### IV. Platform Architecture

The automobile incident data networking platform 100 may be embodied as, for example, but not be limited to, a website, a web application, a desktop application, and a mobile application compatible with a computing device. The computing device may comprise, but not be limited to, a desktop computer, laptop, a tablet, or mobile telecommunications device. Moreover, the automobile incident data networking platform 100 may be hosted on a centralized server, such as, for example, a cloud computing service. Although method 200 has been described to be performed by a computing device 1500, it should be understood that, in some embodiments, different operations may be performed by different networked elements in operative communication with computing device 1500.

Embodiments of the present disclosure may comprise a system having a memory storage and a processing unit. The processing unit coupled to the memory storage, wherein the processing unit is configured to: receive a selection on an incident type; receive incident data; determine a plurality of service providers associated with handling the incident type; display the plurality of service providers for selection; receive a selection of at least one of the plurality of service providers; and communicate the incident data to the at least one selected service provider.

FIG. 15 is a block diagram of a system including computing device 1500. Consistent with an embodiment of the disclosure, the aforementioned memory storage and processing unit may be implemented in a computing device, such as computing device 1500 of FIG. 15. Any suitable combination of hardware, software, or firmware may be used to implement the memory storage and processing unit. For example, the memory storage and processing unit may be implemented with computing device 1500 or any of other computing devices 1518, in combination with computing device 1500. The aforementioned system, device, and processors are examples and other systems, devices, and processors may comprise the aforementioned memory storage and processing unit, consistent with embodiments of the disclosure.

With reference to FIG. 15, a system consistent with an embodiment of the disclosure may include a computing device, such as computing device 1500. In a basic configuration, computing device 1500 may include at least one processing unit 1502 and a system memory 1504. Depending on the configuration and type of computing device, system memory 1504 may comprise, but is not limited to, volatile (e.g., random access memory (RAM)), non-volatile (e.g., read-only memory (ROM)), flash memory, or any combination. System memory 1504 may include operating system 1505, one or more programming modules 1506, and may include a program data 1507. Operating system 1505, for example, may be suitable for controlling computing device 1500's operation. In one embodiment, programming modules 1506 may include data capture, data storing and data transmission. Furthermore, embodiments of the disclosure may be practiced in conjunction with a graphics library, other operating systems, or any other application program and is not limited to any particular application or system. This basic configuration is illustrated in FIG. 15 by those components within a dashed line 1508.

Computing device 1500 may have additional features or functionality. For example, computing device 1500 may also include additional data storage devices (removable and/or non-removable) such as, for example, magnetic disks, optical disks, or tape. Such additional storage is illustrated in FIG. 15 by a removable storage 1509 and a non-removable storage 1510. Computer storage media may include volatile and nonvolatile, removable and non-removable media implemented in any method or technology for storage of information, such as computer readable instructions, data structures, program modules, or other data. System memory 1504, removable storage 1509, and non-removable storage 1510 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1500. Any such computer storage media may be part of device 1500. Computing device 1500 may also have input device(s) 1512 such as a keyboard, a mouse, a pen, a sound input device, a touch input device, etc. Output device(s) 1514 such as a display, speakers, a printer, etc. may also be included. The aforementioned devices are examples and others may be used.

Computing device 1500 may also contain a communication connection 1516 that may allow device 1500 to communicate with other computing devices 1518, such as over a network in a distributed computing environment, for example, an intranet or the Internet. Communication connection 1516 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1504, including operating system 1505. While executing on processing unit 1502, programming modules 1506 (e.g., data capture application 1520) may perform processes including, for example, one or more of methods 200A and 200B's stages as described above. The aforementioned process is an example, and processing unit 1502 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and the property of the Applicant. The Applicant retains and reserves all rights in the code included herein, and grants permission to reproduce the material only in connection with reproduction of the granted patent and for no other purpose.

### V. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

We claim the following:

1. A method comprising:
receiving a selection on an incident type;
receiving incident data;
determining a plurality of service providers associated with handling the incident type;
displaying the plurality of service providers for selection;
receiving a selection of at least one of the plurality of service providers; and
communicating the incident data to the at least one selected service provider.

2. The method of claim 1, further comprising:
receiving, form the at least one service provider, at least one quote for a fee for handling the incident type; and
displaying the at least one quote to a user associated with the incident data.

3. The method of claim 1, wherein communicating the incident data comprises redacting a portion of the incident data.

4. The method of claim 1, wherein receiving the incident data comprises providing at least one interface for inputting the incident data.

5. The method of claim 4, wherein the at least one interface enables a user to input at least one of the following: pictures associated with the incident, vehicle information associated with the incident, location information associated with the incident, first responder information associated with the incident, witness data associated with the incident, and ticket data associated with the incident.

6. The method of claim 1, wherein receiving an incident type comprises receiving an indication that the incident type comprises a ticket.

7. The method of claim 6, further comprising, providing a ticket input interface in response to the indication.

8. The method of claim 7, wherein the ticket input interface enables the user to take a picture of the ticket.

9. The method of claim 1, wherein receiving an incident type comprises receiving an indication that the incident type comprises an emergency.

10. The method of claim 9, further comprising detecting a user's location in response to the indication.

11. The method of claim 10, further comprising notifying at least one contact of the emergency, the notification comprising the user's location data.

12. The method of claim 11, wherein the at least one contact is pre-determined by the user.

13. A system comprising:
a memory storage; and
a processing unit coupled to the memory storage, wherein the processing unit is configured to:
receive a selection on an incident type;
receive incident data;
determine a plurality of service providers associated with handling the incident type;
display the plurality of service providers for selection;
receive a selection of at least one of the plurality of service providers; and
communicate the incident data to the at least one selected service provider.

14. The system of claim 13, wherein the processing unit is further configured to:
receive, form the at least one service provider, at least one quote for a fee for handling the incident type;
display the at least one quote to a user associated with the incident data; and
facilitate a communication between the user and the at least one service provider.

15. The system of claim 13, wherein the processing unit being configured to communicate the incident data comprises the processing unit being configured to redact a portion of the incident data.

16. The system of claim 13, wherein the processing unit being configured to receive the incident data comprises the processing unit being configured to provide at least one interface for inputting the incident data.

17. The method of claim 4, wherein the at least one interface enables a user to input at least one of the following: pictures associated with the incident, vehicle information associated with the incident, location information associated with the incident, first responder information associated with the incident, witness data associated with the incident, and ticket data associated with the incident.

18. A non-transitory computer readable medium comprising a set of instructions which when executed causes a computing device to perform a method comprising:
receiving a selection on an incident type;
receiving incident data;
determining a plurality of service providers associated with handling the incident type;
displaying the plurality of service providers for selection;
receiving a selection of at least one of the plurality of service providers; and
communicating the incident data to the at least one selected service provider.

19. The non-transitory computer readable medium of claim 18, further comprising:
receiving, form the at least one service provider, at least one quote for a fee for handling the incident type; and
displaying the at least one quote to a user associated with the incident data.

20. The non-transitory computer readable medium of claim 18, wherein communicating the incident data comprises redacting a portion of the incident data.
